(19) United States
(12) Patent Application Publication
(10) Pub. No.: US 2025/0024300 A1
(43) Pub. Date: Jan. 16, 2025

(54) TECHNIQUES FOR INDICATING WIRELESS CHANNEL INFORMATION RELATED TO POSITIONING

(71) Applicant: ZTE Corporation, Shenzhen (CN)

(72) Inventors: Guozeng ZHENG, Shenzhen (CN); Zhaohua LU, Shenzhen (CN); Huahua XIAO, Shenzhen (CN)

(21) Appl. No.: 18/898,389

(22) Filed: Sep. 26, 2024

Related U.S. Application Data
(63) Continuation of application No. PCT/CN2022/107469, filed on Jul. 22, 2022.

(51) Int. Cl. H04W 24/10; H04B 17/318

(52) U.S. Cl. CPC H04W 24/10; H04B 17/328

(57) ABSTRACT

Techniques are described for indicating wireless channel information related to positioning. An example wireless communication method comprises receiving, by a first wireless device from a second device, a request message that requests the first wireless device to report at least a path phase of a channel path; and transmitting, to the second device and in response to the request message, the path phase of the channel path.

### CROSS-REFERENCE TO RELATED APPLICATION

This application is a continuation and claims priority to International Application No. PCT/CN2022/107469, filed on Jul. 22, 2022, the disclosure of which is hereby incorporated by reference herein in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for indicating wireless channel information related to positioning.

A first wireless communication method includes receiving, by a first wireless device from a second device, a request message that requests the first wireless device to report at least a path phase of a channel path; and transmitting, to the second device and in response to the request message, the path phase of the channel path.

In some embodiments, the request message requests the first wireless device to report the path phase, a path timing, and a path power of the channel path, and the first wireless device transmits a set of data comprising the path phase, the path timing, and the path power in response to the request message. In some embodiments, the first wireless device includes a communication device. In some embodiments, the path power is a downlink reference signal received path power. In some embodiments, the set of data comprising the path phase, the path timing, and the path power is transmitted to the second device in a downlink measurement report using a downlink time difference of arrival (DL TDOA) positioning method and/or a Multi-cell round trip time (Multi-RTT) positioning method. In some embodiments, prior to the receiving the request message by the communication device, the communication device transmits to the second device an indication that indicates that the communication device has a capability to report the path phase, and the request message is received in response to transmitting the indication.

In some embodiments, the first wireless device includes a base station (e.g., a TRP or gNB). In some embodiments, the path power is an uplink reference signal received path power. In some embodiments, the set of data comprising the path phase, the path timing, and the path power is transmitted to the second device in an uplink measurement report using an uplink time difference of arrival (UL TDOA) positioning method and/or a Multi-cell round trip time (Multi-RTT) positioning method.

A second wireless communication method includes transmitting, by a second device to a first wireless device, a request message that requests the first wireless device to report at least a path phase of a channel path; and receiving, from the first wireless device and in response to the request message, the path phase of the channel path.

In some embodiments, the request message requests the first wireless device to report the path phase, a path timing, and a path power of the channel path, and the second device receives a set of data comprising the path phase, the path timing, and the path power in response to the request message. In some embodiments, the first wireless device includes a communication device, and the second device includes a location entity (e.g., LMF). In some embodiments, the set of data comprising the path phase, the path timing, and the path power is received by the second device in a downlink measurement report using a downlink time difference of arrival (DL TDOA) positioning method and/or a Multi-cell round trip time (Multi-RTT) positioning method. In some embodiments, prior to the transmitting the request message by the second device, the second device receives an indication that indicates that the communication device has a capability to report the path phase, and the request message is transmitted in response to receiving the indication.

In some embodiments, the first wireless device includes a base station (e.g., TRP or gNB), and the second device includes a location entity (e.g., LMF). In some embodiments, the set of data comprising the path phase, the path timing, and the path power is received by the second device in an uplink measurement report using an uplink time difference of arrival (UL TDOA) positioning method and/or a Multi-cell round trip time (Multi-RTT) positioning method.

A third wireless communication method includes receiving, by a first wireless device from a second device, a request message that requests the first wireless device to report at least one measurement result based on a multi-port reference signal; and transmitting, to the second device and in response to the request message, a measurement report that includes the at least one measurement result and a port index indication, where the port index indication corresponds to an antenna port of the multi-port reference signal.

In some embodiments, the first wireless device includes a base station (e.g., TRP or gNB), where the at least one measurement result includes any one or more of the following: an uplink reference signal received power corresponding to the multi-port reference signal, an uplink reference signal received path power corresponding to the multi-port reference signal, an uplink angle of arrival (UL-AOA) corresponding to the multi-port reference signal, an uplink relative time of arrival (UL-RTOA) corresponding to the multi-port reference signal, a Rx-Tx time difference corresponding to the multi-port reference signal, and a path phase corresponding to the multi-port reference signal. In some embodiments, the first wireless device includes a communication device, where the at least one measurement result includes any one or more of the following: a downlink reference signal received power corresponding to the multi-port reference signal, a downlink reference signal received path power corresponding to the multi-port reference signal, a downlink reference signal time difference (DL-RSTD) corresponding to the multi-port reference signal, a Rx-Tx time difference corresponding to the multi-port reference signal, and a path phase corresponding to the multi-port reference signal.

In some embodiments, the measurement report includes multiple path measurement results that corresponding to different port indexes of the multi-port reference signal, and the multiple path measurement results are associated with a same path timing. In some embodiments, the multiple path measurement results include any one or more of the following for a downlink measurement report: a downlink reference signal received path power corresponding to the multi-port reference signal, and a path phase corresponding to the multi-port reference signal. In some embodiments, the multiple path measurement results include any one or more of the following for an uplink measurement report: an uplink reference signal received path power corresponding to the multi-port reference signal, and a path phase corresponding to the multi-port reference signal. In some embodiments, the multiple path measurement results include multiple path phases, one path phase of the multiple path phases is reported with an absolute value, and each of remaining path phases of the multiple path phases is reported with a value relative to the absolute value of the one path phase.

A fourth wireless communication method includes transmitting, by a second device to a first wireless device, a request message that requests the first wireless device to report at least one measurement result based on a multi-port reference signal; and receiving, by the second device and in response to the request message, a measurement report that includes the at least one measurement result and a port index indication, where the port index indication corresponds to an antenna port of the multi-port reference signal.

In some embodiments, the first wireless device includes a base station (e.g., TRP or gNB), the second device includes a location entity (e.g., LMF), where the at least one measurement result includes any one or more of the following: an uplink reference signal received power corresponding to the multi-port reference signal, an uplink reference signal received path power corresponding to the multi-port reference signal, an uplink angle of arrival (UL-AOA) corresponding to the multi-port reference signal, an uplink relative time of arrival (UL-RTOA) corresponding to the multi-port reference signal, a Rx-Tx time difference corresponding to the multi-port reference signal, and a path phase corresponding to the multi-port reference signal.

In some embodiments, the first wireless device includes a communication device, the second device includes a location entity (e.g., LMF), where the at least one measurement result includes any one or more of the following: a downlink reference signal received power corresponding to the multi-port reference signal, a downlink reference signal received path power corresponding to the multi-port reference signal, a downlink reference signal time difference (DL-RSTD) corresponding to the multi-port reference signal, a Rx-Tx time difference corresponding to the multi-port reference signal, and a path phase corresponding to the multi-port reference signal.

A fifth wireless communication method includes operating a model by a first wireless device, where the model determines an output data based on an input data associated with channel information.

In some embodiments, the channel information includes a plurality of channel paths, the first wireless device receives an information indicating a total number of the plurality of channel paths. In some embodiments, the first wireless device receives a time gap information that indicates a time gap between two consecutive channel paths included in the input data. In some embodiments, the first wireless device receives a quantization accuracy indication of an element included in the input data, the element includes any one or more of the following: a first power of a channel path, a second power of an in-phase of the channel path, a third power of a quadrature part of the channel path, or a path phase. In some embodiments, the input data include channel information from a multi-port reference signal.

In some embodiments, the input data include channel information related to a power and a phase of a channel path. In some embodiments, the input data includes channel information related to a power of an in-phase and a quadrature part of a channel path. In some embodiments, the input data includes channel information related to multiple reference signals received from a same transmission reception point (TRP) device. In some embodiments, the output data includes any one or more of the following: a location of a communication device, at least one confidence level, a timing information, or a reference signal received power (RSRP) information. In some embodiments, the timing information includes at least one reference signal time difference value, and the at least one downlink reference signal time difference value is a relative timing difference between a neighbor transmission reception point (TRP) and a reference TRP. In some embodiments, the RSRP information includes at least one reference signal received path power value, wherein the at least one reference signal received path power value is a differential value between a reference signal received path power value corresponding to a target reference signal and another reference signal received path power value corresponding to another reference signal.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an architecture for a user equipment (UE) positioning system.

FIG. 2 shows an example model having a model input and a model output.

FIG. 3 shows an exemplary flowchart for transmitting a path phase of a channel path.

FIG. 4 shows an exemplary flowchart for receiving a path phase of a channel path.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows an exemplary flowchart for transmitting a measurement report.

FIG. 8 shows an exemplary flowchart for receiving a measurement report.

FIG. 9 shows an exemplary flowchart for operating a model.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Conventional positioning methods are based on timing measurements or angle measurements, which heavily depend on the Light of Sight (LoS) conditions of a scenario. Meanwhile, due to the limitations of channel bandwidth and antenna number, the estimation accuracy of timing or angle cannot meet the requirements of rapid development of applications. In this patent document, technical solutions are proposed to increase the positioning performance in three aspects: 1) methods to report measurements of channel phase; 2) methods to report measurements from multiple port reference signals; 3) methods to use Artificial Intelligence/Machine Learning (AI/ML) techniques to increase the positioning performance.

Current 5G NR positioning system supports the following solutions for positioning:
UL-based (uplink) positioning solutions (e.g., Uplink Enhanced Cell ID (UL-ECID) positioning method, Uplink Angle Of Arrival (UL-AOA) positioning method, Uplink Time Difference Of Arrival (UL-TDOA) positioning method)
DL-based (downlink) positioning solutions (e.g., Downlink Enhanced Cell ID (DL-ECID) positioning method, Downlink Angle Of Arrival (DL-AoD) positioning method, Downlink Time Difference of Arrival (DL-TDOA) positioning method)
DL+UL based positioning solution (e.g., Multi-cell Round Trip Time (Multi-RTT) positioning method).

For UL measurement at transmission reception point (TRP)/gNB side, uplink reference signals are detected for acquiring different UL measurements, so that the TRP/gNB can determine and report at least one of the following measurements:
UL sounding reference signal reference signal received power (UL SRS-RSRP), which can be reported in UL measurement report for UL-AOA, UL-TDOA or Multi-RTT positioning methods.
UL SRS reference signal received path power (UL SRS-RSRPP), which can be reported in UL measurement report for UL-AOA, UL-TDOA or Multi-RTT positioning methods.
UL-AOA (e.g., azimuth angle and vertical angle), which can be reported in UL measurement report for UL-AOA positioning method.
UL Relative Time of Arrival (UL-RTOA), which can be reported in UL measurement report for UL-RTOA positioning method.
gNB Rx-Tx time difference, which can be reported in UL measurement report for Multi-RTT positioning method.

For DL measurement at UE side, downlink reference signals are measured for acquiring different DL measurements, so that the UE can determine and report at least one of the following measurements:
Downlink positioning reference signal reference signal received power (DL PRS-RSRP), which can be reported in DL measurement report for DL-AOD, downlink reference signal time difference (DL-RSTD) or Multi-RTT positioning methods.
DL PRS reference signal received path power (DL PRS-RSRPP), which can be reported in DL measurement report for DL-AOD, DL-RSTD or Multi-RTT positioning methods.
DL reference signal time difference (DL-RSTD), which can be reported in a DL measurement report for DL-TDOA positioning method.
UE Rx-Tx time difference, which can only be reported in a DL measurement report for Multi-RTT positioning method.

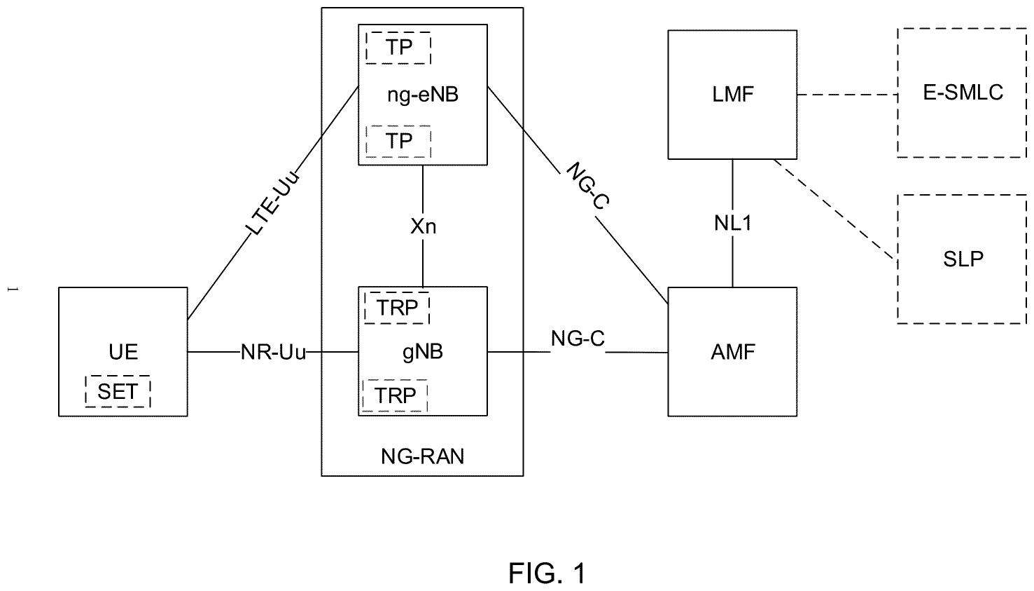

FIG. 1 shows an architecture for a user equipment (UE) positioning system. Using FIG. 1, an example of procedures for UL measurement report is as follows:
The UL measurement report is requested by a device that includes a location management function (LMF) to TRP/gNB, where one of the UL measurements mentioned above is requested to be reported in the UL measurement report. The request signaling may also include configurations of reference signals (e.g., sounding reference signals) for use in the UL measurement report.
TRP/gNB measures the reference signals and reports the UL measurement report as indicated by LMF.

Using FIG. 1, an example of procedures for DL measurement report is as follows:
LMF provides assistance data to UE. The assistance data includes configurations of reference signals (e.g., DL PRS) that are expected to be measured by UE.
The DL measurement report is requested by LMF to UE, which indicates which positioning method and DL measurement are required to report.
UE measures reference signals and reports the DL measurement report as indicated by LMF.

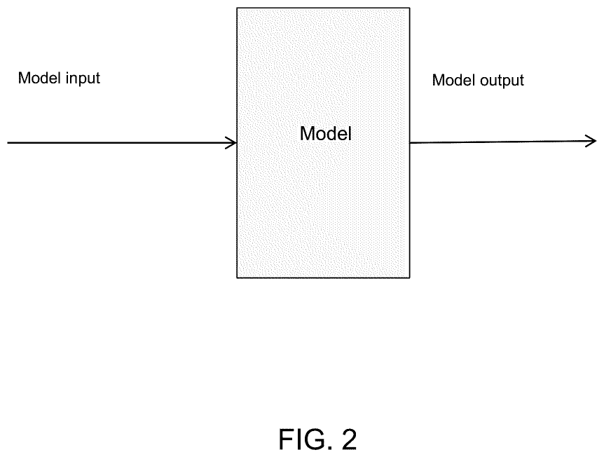

AI/ML can be used to extract features that cannot be derived by mathematical methods. In this patent document, proposed technical solutions are also targeted on using AI/ML techniques to increase positioning performance. Generally, AI/ML model is a data driven algorithm that applies AI/ML techniques to generate/determine a set of outputs based on a set of inputs, which includes three parts as shown in FIG. 2.
Model input: The data fed into a model
Model output: The output of a model
Model: An algorithm to derive/determine the relationship between model input and model output

This patent document will discuss how to define model input and output when it's used for location estimation or increase of estimation accuracy of measurements. In addition, AI/ML model is an exemplary scenario, where the technical solutions described in this patent document can be generalized or applicable to any model that determines a relationship between an input and an output.

In this patent document, technical solutions are proposed that can increase the positioning performance in at least three aspects: 1) methods to report measurements of path phase; 2) methods to report measurements from multiple port reference signals; 3) methods to use AI/ML techniques to increase the positioning performance.

### II. Measurements

### II. (a). Channel Path Information

Currently, UE/TRP can report reference signal received path power (e.g., DL PRS-RSRPP and UL SRS-RSRPP) of a channel path. However, a given channel path (or a channel impulse response in a given delay) generally includes in-phase part (or real part) and quadrature part (or imaginary part) as shown in the following equation,

$$h ( n ) = \sqrt{P ( n )} \cdot {e}^{j \cdot θ ( n )} = {A}_{I} ( n ) + j \cdot {A}_{Q} ( n )$$

$$where ,$$

$${A}_{I} ( n ) = \sqrt{P ( n )} \cdot cos ( θ ( n ) ) ;$$

$${A}_{Q} ( n ) = \sqrt{P ( n )} \cdot sin ( θ ( n ) )$$

where,
h(n) is a channel path, which is a channel impulse response at n^{th} path delay
P(n) is a path power of the channel path, which can be DL PRS-RSRPP for DL measurement or UL SRS-RSRPP for UL measurement
θ(n) is a path phase of the channel path
A_{I}(n) is an amplitude of in-phase part of of the channel path
A_{Q}(n) is an amplitude of quadrature part of the channel path

In some embodiments, UE can report whether it has the capability to report path phase. For example, a UE can send a message indicating whether it has the capability to report path phase to a LMF; the LMF can send a request to the UE to send the path phase; and the UE, in response to receiving the request, transmits the path phase to the LMF.

In some embodiments, LMF can request UE or TRP to report path phase
In some embodiments, UE or TRP will only report path phase when path power (e.g., DL PRS-RSRPP or UL SRS-RSRPP) is also requested and reported.
In some embodiments, UE or TRP can be requested to report a triple set of {path timing, path power, path phase} for a channel path. Then, UE/TRP reports at least one set of data comprising path timing, path power, and path phase of a channel path.
   The path power is DL PRS-RSRPP for DL measurement or UL SRS-RSRPP for UL measurement
   The triple set can be reported to LMF via a DL measurement report using DL TDOA positioning method and/or Multi-RTT positioning method
   The triple set can be reported to LMF via a UL measurement report using UL TDOA positioning method and/or Multi-RTT positioning method
In some embodiments, LMF can indicate to UE or TRP about the reporting granularity (or resolution) of path phase measurement. For example, reporting granularity can be one of the values from {1°, 2°, 5°, 10°}.
In some embodiments, UE or TRP can report which reporting granularity (or resolution) has been used for path phase measurement. For example, reporting granularity can be one of the values from {1°, 2°, 5°, 10°}.

### III. Multiple-Port Reference Signal

Generally, the more information is fed into an AI model, the more inference accuracy is expected. However, current positioning reference signal (uplink or downlink positioning reference signal) only support single port transmission. The following of this section discusses solutions to support multiple-port reference signal.
In some embodiments, UE can report whether it has the capability to support multi-port PRS. For example, a UE can send a message indicating whether it has the capability to support multi-port PRS to a LMF; the LMF can send a request to the UE to send a report related to multi-port PRS related measurements; and the UE, in response to receiving the request, transmits a report comprising measurements based on multi-port PRS to the LMF.
In some embodiments, LMF can request UE or TRP to report measurement based on multi-port PRS. For example, a TRP or base station can transmit a single PRS to a UE using multiple antenna ports. In another example, a UE can transmit a single PRS to a TRP or base station using multiple antenna ports. Each of the antenna ports can be uniquely identified by a port index.
   In a measurement report, a measurement result can be associated with a port index, which is to indicate measurement result is derived/measured from which port of a positioning reference signal.
      For measurement report from TRP to LMF, the measurement result can be any one or more of the following:
         UL SRS-RSRP
         UL SRS-RSRPP
         UL-AOA
         UL-RTOA
         gNB Rx-Tx time difference
         Path phase
      For measurement report from UE to LMF, the measurement result can be any one or more of the following:
         DL PRS-RSRP
         DL PRS-RSRPP
         DL-RSTD
         UE Rx-Tx time difference
         Path phase
   In a measurement report, multiple path measurements corresponding to different port indexes of the same positioning reference signal can be associated with the same path timing.
      In some embodiments, the path measurements can be any one or more of the following for DL measurement:
         DL PRS-RSRPP
         Path phase.
      In some embodiments, the path measurements can be any one or more of the following for UL measurement:
         UL SRS-RSRPP
         Path phase
      In some embodiments, if the multiple path measurements are path phase measurements, one path phase can be reported relatively to a reference path phase. That is, the reference path phase reports an absolute value and remaining path phases are reported by differential values to the absolute value.
         In some embodiments, UE may report which port index of a positioning reference signal whose path phase measurement is reported with an absolute value.
         In some embodiments, the path phase measurement associated with lowest port index of a positioning reference signal is reported with an absolute value by default.
         In some embodiments, the reporting overhead (or the maximum value) of the absolute value is larger than a differential value.
      In some embodiments, if the multiple path measurements are path power (e.g., DL PRS-RSRPP or UL SRS-RSRPP) measurements, one path power can be reported relatively to a reference path power. That is, the reference path power reports an absolute value and remaining path powers are reported by differential values to the absolute value.
         In some embodiments, UE may report which port index of a positioning reference signal whose path power measurement is reported with an absolute value.
         In some embodiments, the path power measurement associated with lowest port index of a positioning reference signal is reported with an absolute value by default.
         In some embodiments, the reporting overhead (or the maximum value) of the absolute value is larger than a differential value.
In some embodiments, LMF can the request to TRP to configure multiple-port PRS (the PRS can be DL PRS or SRS for positioning). Furthermore, the request message can also include any one or more of the following information:
   The number of ports for PRS
   Time domain information (e.g., time domain allocation in a slot)
   Frequency domain information (e.g., frequency domain allocation in a resource block)
   The type of Code Division Multiplexing (CDM), which can at least include one of the following type:
      No CDM
      Frequency Domain CDM (FD-CDM)
      Time Domain CDM (TD-CDM).
      FD-CDM and TD-CDM
   The number of CDM groups

### IV. AI Input Data and AI Output Data

In this section, some solutions are described to describe or define AI model input and AI model output for positioning. Generally, the AI model can be used to derive UE location directly or increase the estimation accuracy of measurements that are related to positioning. The AI model can be located and operated in a UE, gNB/TRP, and/or LMF.
In some embodiments, a data used for an AI model input is associated with channel information:
   In some embodiments, UE/TRP is informed/indicated/configured with the number of channel paths (or the number of channel impulse responses corresponding to different time delays) included in the data.
      In some embodiments, a time gap (or time granularity) between two adjacent (or consecutive) channel paths included in the data should also be informed to UE/TRP. Furthermore, the time gap should be the same for any two adjacent (or consecutive) channel paths included in the data.
   In some embodiments, UE/TRP is informed/indicated/configured with the quantization accuracy (e.g., number of bits to quantize a coefficient) of a coefficient (or the element/weight) included in the data, where the coefficient can be one of the following:
      Power/amplitude of a channel path
      Power/amplitude of in-phase of a channel path
      Power/amplitude of quadrature part of a channel path
      Path phase
   In some embodiments, the data includes measurement results from multiple port PRS
      In some embodiments, UE/TRP is informed/indicated/configured with the order/sequence of measurement results to be included/placed in the data where the measurements correspond to different port index of a positioning reference signal.
         For example, the measurement corresponding to a lower port index of a positioning reference signal has a higher priority than another measurement corresponding to a higher port index of the same positioning reference signal.
   In some embodiments, the data includes measurement results of at least one path power and path phase of a channel path.
      In some embodiments, UE/TRP is informed/indicated/configured with the order/sequence of path power and path phase of a channel path to be included/placed in the data.
   In some embodiments, the data includes measurement results of at least one power/amplitude of in-phase and quadrature part of a channel path
      In some embodiments, UE/TRP is informed/indicated/configured with the order/sequence of power/amplitude of in-phase and quadrature part of a channel path to be included/placed in the data.
         For example, the measurement result corresponding to power/amplitude of in-phase part of a channel path has a higher priority than another measurement result corresponding to power/amplitude of quadrature part of the same channel path.
   In some embodiments, the data includes measurement results from multiple positioning reference signals transmitted from the same TRP.
      In some embodiments, the measurement results from some selected positioning reference signals can be included in the data. The selected positioning reference signals should be indicated to the device who performances the operation of the AI model.
         In some embodiments, selected positioning reference signals should be from the same resource set of positioning reference signal (e.g., the same DL PRS resource set or SRS resource set).
         In some embodiments, selected positioning reference signals should be from the same component carrier.
      In some embodiments, UE is informed/indicated/configured with the order/sequence of measurements from multiple positioning reference signals to be included/placed in the data.
         For example, the order is according to the positioning reference signal identifiers.
         For example, the order is according to the resource set identifiers of the positioning reference signals.
         For example, the order is according to the component carrier identifiers of positioning reference signals.
   In some embodiments, the data includes measurement results from multiple positioning reference signals transmitted from different TRPs.
      In some embodiments, the measurements from some selected TRPs can be included in the data. The selected TRPs should be indicated to the device who performances the operation of the AI model.
      In some embodiments, UE is informed/indicated/configured with the order/sequence of measurements from different TRPs to be included/placed in the data.
         For example, the order is according to the TRP identifiers.
      In some embodiments, only measurement results from some selected positioning reference signals in each of the selected TRPs can be included in the data.
   In some embodiments, the data include the measurement results whose corresponding positioning reference signals are received by UE based on the same receiving beam assumption, where the same receiving beam assumption can be one of the following:
      The same receiving beam index
      The same spatial receiving parameter (or the same receiving spatial filter)
   In some embodiments, the data include the measurement results whose corresponding positioning reference signals are received by UE based on the same receiving timing error assumption.
      For example, the receiving timing errors (or receiving timing error differences) experienced by different positioning reference signals should be within the same margin.
In some embodiments, an AI model output may be one of the following:
   A UE location, either be a two dimensional UE location or a three dimensional UE location
   At least one confidence level value
      It be the confidence level of a channel being a LoS (Line of Sight) channel or a NLOS (Non-Line of Sight) channel. For example, the measurement results included in the data used for an AI model input are associated with a channel experienced by a positioning reference signal. The AI model output is to determine the confidence level of the channel being a LoS (Line of Sight) channel or a NLOS (Non-Line of Sight) channel.
         In some embodiments, the number of confidence level values in an AI model output should be indicated to the device who performances the operation of the AI model.
         In some embodiments, the number of confidence level values in an AI model output is determined according to the number of reference signals included in the data for an AI model input.
         In some embodiments, the number of confidence level values in an AI model output is determined according to the number of TRPs included in the data for an AI model input.
      It can be the confidence level of the validity of the AI model. For example, if the value equals/approximates to 0, which means the AI model is not longer valid. And, if the value equals/approximates to 1, which means the AI model works well.
   Timing information
      The timing information may include at least one reference signal time difference value (e.g, a DL-RSTD value or a UL-RTOA value), which is a relative timing difference between a neighbour TRP and a reference TRP.
         In some embodiments, UE should be informed that which TRP is the reference TRP.
         In some embodiments, UE can report that which TRP is the reference TRP.
         In some embodiments, the reference signal time difference value value may only be related to first detected channel path in time.
         In some embodiments, the number of reference signal time difference values in an AI model output should be indicated to the device who performances the operation of the AI model.
         In some embodiments, the number of reference signal time difference values in an AI model output is determined according to the number of reference signals included in the data for an AI model input.
         In some embodiments, the number of reference signal time difference values in an AI model output is determined according to the number of TRPs included in the data for an AI model input.
   RSRP information
      The RSRP information may include at least one reference signal received power value (e.g., a DL-PRS-RSRP value or a UL-SRS-RSRP value), which may be a differential value between one RSRP corresponding to a target PRS and another RSRP corresponding to a reference PRS.
         In some embodiments, UE should be informed that which PRS is the reference PRS.
         In some embodiments, UE can report that which PRS is the reference PRS.
         In some embodiments, if the AI model output includes multiple RSRP values, the multiple RSRP values should be associated with the same TRP. Furthermore, multiple RSRP values are also associated with the same reference PRS.
         In some embodiments, the number of reference signal received power values in an AI model output should be indicated to the device who performances the operation of the AI model.
         In some embodiments, the number of reference signal received power values in an AI model output is determined according to the number of reference signals included in the data for an AI model input.
         In some embodiments, the number of reference signal received power values in an AI model output is determined according to the number of TRPs included in the data for an AI model input.
      The RSRP information may include at least one reference signal received path power value (e.g., a DL-PRS-RSRPP value or UL-SRS-RSRPP), which may be a differential value between one RSRPP corresponding to a target PRS and another RSRPP corresponding to a reference PRS.
         In some embodiments, UE should be informed that which PRS is the reference PRS.
         In some embodiments, UE can report that which PRS is the reference PRS.
         In some embodiments, if the AI model output includes multiple RSRPP values, the multiple RSRPP values should be associated with the same TRP. Furthermore, multiple RSRPP values are also associated with the same reference PRS.
         In some embodiments, the RSRPP value is only be RSRPP for the 1^{st} path delay, so the RSRPP is the power contribution corresponding to the first detected channel path in time.
         In some embodiments, the number of reference signal received path power values in an AI model output should be indicated to the device who performances the operation of the AI model.
         In some embodiments, the number of reference signal received path power values in an AI model output is determined according to the number of reference signals included in the data for an AI model input.
         In some embodiments, the number of reference signal received path power values in an AI model output is determined according to the number of TRPs included in the data for an AI model input.
In some embodiments, UE is to implement/execute/infer/operate the AI model.
In some embodiments, TRP/gNB is to implement/execute/infer/operate the AI model.
In some embodiments, the AI model output should be reported to LMF in a measurement report.
   In the measurement report, at least one field should indicate that the measurement results are from an AI model output.
   In some embodiments, a device can operate the same AI model multiple times based on different data used for the AI model output, each time of the AI model operation corresponds to a set of AI model output. Each set of the AI model output included in the measurement report may be uniquely identified by an identifier.
   In some embodiments, a value in an AI model output should be associated with one of the following information:
      TRP identifier
      Reference signal resource set identifier
      Reference signal resource identifier
   In some embodiments, all values in an AI model output should be reported.

This patent document describes, among other techniques, techniques to report path phase by UE and TRP, techniques to report measurements from multiple port PRS by UE and TRP, and techniques to define the AI model input and AI model output

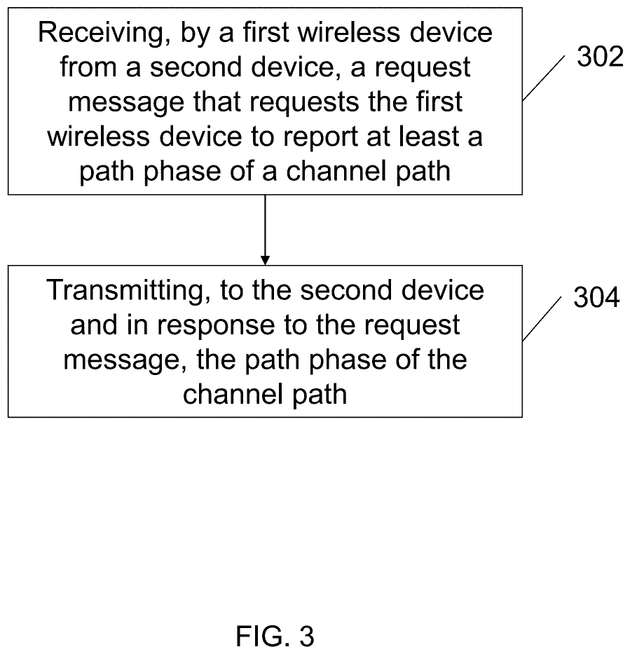

FIG. 3 shows an exemplary flowchart for transmitting a path phase of a channel path. Operation 302 includes receiving, by a first wireless device from a second device, a request message that requests the first wireless device to report at least a path phase of a channel path. Operation 304 includes transmitting, to the second device and in response to the request message, the path phase of the channel path.

In some embodiments, the request message requests the first wireless device to report the path phase, a path timing, and a path power of the channel path, and the first wireless device transmits a set of data comprising the path phase, the path timing, and the path power in response to the request message. In some embodiments, the first wireless device includes a communication device. In some embodiments, the path power is a downlink reference signal received path power. In some embodiments, the set of data comprising the path phase, the path timing, and the path power is transmitted to the second device in a downlink measurement report using a downlink time difference of arrival (DL TDOA) positioning method and/or a Multi-cell round trip time (Multi-RTT) positioning method. In some embodiments, prior to the receiving the request message by the communication device, the communication device transmits to the second device an indication that indicates that the communication device has a capability to report the path phase, and the request message is received in response to transmitting the indication.

In some embodiments, the first wireless device includes a base station (e.g., a TRP or gNB). In some embodiments, the path power is an uplink reference signal received path power. In some embodiments, the set of data comprising the path phase, the path timing, and the path power is transmitted to the second device in an uplink measurement report using an uplink time difference of arrival (UL TDOA) positioning method and/or a Multi-cell round trip time (Multi-RTT) positioning method.

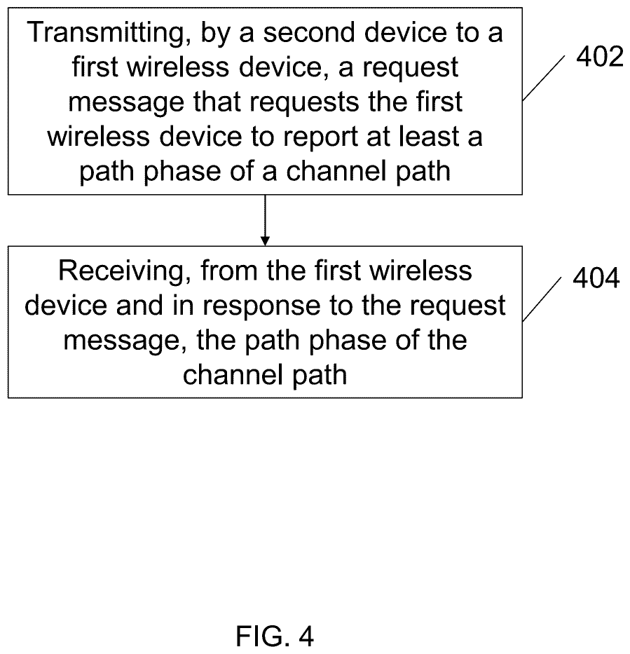

FIG. 4 shows an exemplary flowchart for receiving a path phase of a channel path. Operation 402 includes transmitting, by a second device to a first wireless device, a request message that requests the first wireless device to report at least a path phase of a channel path. Operation 404 includes receiving, from the first wireless device and in response to the request message, the path phase of the channel path.

In some embodiments, the request message requests the first wireless device to report the path phase, a path timing, and a path power of the channel path, and the second device receives a set of data comprising the path phase, the path timing, and the path power in response to the request message. In some embodiments, the first wireless device includes a communication device, and the second device includes a location entity (e.g., LMF). In some embodiments, the set of data comprising the path phase, the path timing, and the path power is received by the second device in a downlink measurement report using a downlink time difference of arrival (DL TDOA) positioning method and/or a Multi-cell round trip time (Multi-RTT) positioning method. In some embodiments, prior to the transmitting the request message by the second device, the second device receives an indication that indicates that the communication device has a capability to report the path phase, and the request message is transmitted in response to receiving the indication.

In some embodiments, the first wireless device includes a base station (e.g., TRP or gNB), and the second device includes a location entity (e.g., LMF). In some embodiments, the set of data comprising the path phase, the path timing, and the path power is received by the second device in an uplink measurement report using an uplink time difference of arrival (UL TDOA) positioning method and/or a Multi-cell round trip time (Multi-RTT) positioning method.

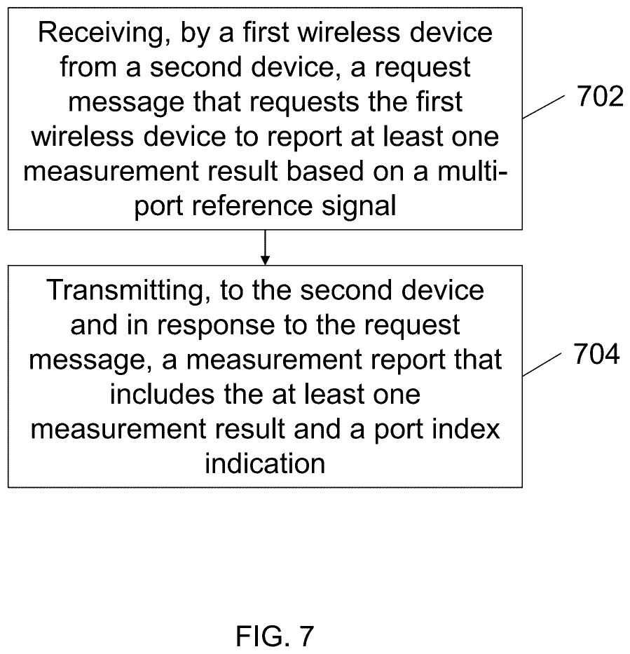

FIG. 7 shows an exemplary flowchart for transmitting a measurement report. Operation 702 includes receiving, by a first wireless device from a second device, a request message that requests the first wireless device to report at least one measurement result based on a multi-port reference signal. Operation 704 includes transmitting, to the second device and in response to the request message, a measurement report that includes the at least one measurement result and a port index indication, where the port index indication corresponds to an antenna port of the multi-port reference signal.

In some embodiments, the first wireless device includes a base station (e.g., TRP or gNB), where the at least one measurement result includes any one or more of the following: an uplink reference signal received power corresponding to the multi-port reference signal, an uplink reference signal received path power corresponding to the multi-port reference signal, an uplink angle of arrival (UL-AOA) corresponding to the multi-port reference signal, an uplink relative time of arrival (UL-RTOA) corresponding to the multi-port reference signal, a Rx-Tx time difference corresponding to the multi-port reference signal, and a path phase corresponding to the multi-port reference signal. In some embodiments, the first wireless device includes a communication device, where the at least one measurement result includes any one or more of the following: a downlink reference signal received power corresponding to the multi-port reference signal, a downlink reference signal received path power corresponding to the multi-port reference signal, a downlink reference signal time difference (DL-RSTD) corresponding to the multi-port reference signal, a Rx-Tx time difference corresponding to the multi-port reference signal, and a path phase corresponding to the multi-port reference signal.

In some embodiments, the measurement report includes multiple path measurement results that corresponding to different port indexes of the multi-port reference signal, and the multiple path measurement results are associated with a same path timing. In some embodiments, the multiple path measurement results include any one or more of the following for a downlink measurement report: a downlink reference signal received path power corresponding to the multi-port reference signal, and a path phase corresponding to the multi-port reference signal. In some embodiments, the multiple path measurement results include any one or more of the following for an uplink measurement report: an uplink reference signal received path power corresponding to the multi-port reference signal, and a path phase corresponding to the multi-port reference signal. In some embodiments, the multiple path measurement results include multiple path phases, one path phase of the multiple path phases is reported with an absolute value, and each of remaining path phases of the multiple path phases is reported with a value relative to the absolute value of the one path phase.

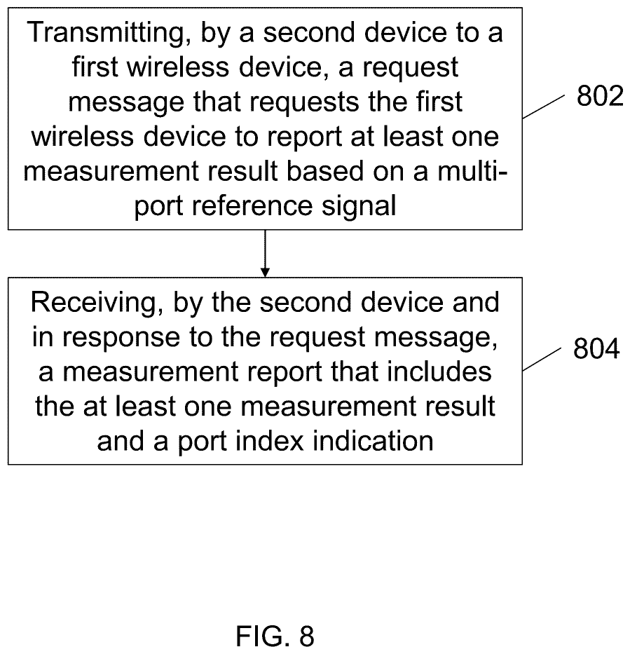

FIG. 8 shows an exemplary flowchart for receiving a measurement report. Operation 802 includes transmitting, by a second device to a first wireless device, a request message that requests the first wireless device to report at least one measurement result based on a multi-port reference signal. Operation 804 includes receiving, by the second device and in response to the request message, a measurement report that includes the at least one measurement result and a port index indication, where the port index indication corresponds to an antenna port of the multi-port reference signal.

In some embodiments, the first wireless device includes a base station (e.g., TRP or gNB), the second device includes a location entity (e.g., LMF), where the at least one measurement result includes any one or more of the following: an uplink reference signal received power corresponding to the multi-port reference signal, an uplink reference signal received path power corresponding to the multi-port reference signal, an uplink angle of arrival (UL-AOA) corresponding to the multi-port reference signal, an uplink relative time of arrival (UL-RTOA) corresponding to the multi-port reference signal, a Rx-Tx time difference corresponding to the multi-port reference signal, and a path phase corresponding to the multi-port reference signal.

In some embodiments, the first wireless device includes a communication device, the second device includes a location entity (e.g., LMF), where the at least one measurement result includes any one or more of the following: a downlink reference signal received power corresponding to the multi-port reference signal, a downlink reference signal received path power corresponding to the multi-port reference signal, a downlink reference signal time difference (DL-RSTD) corresponding to the multi-port reference signal, a Rx-Tx time difference corresponding to the multi-port reference signal, and a path phase corresponding to the multi-port reference signal.

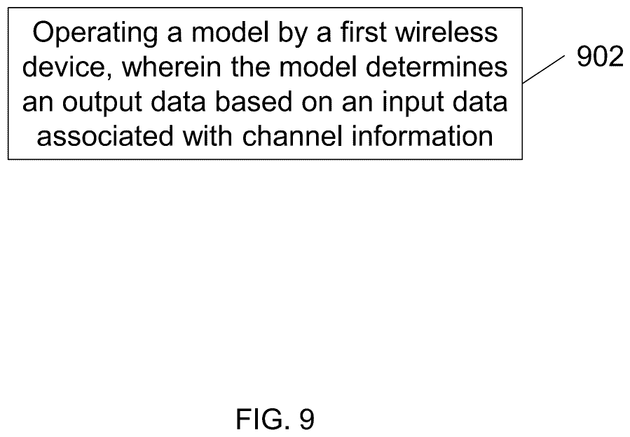

FIG. 9 shows an exemplary flowchart for operating a model. Operation 902 includes operating a model (e.g., AI model) by a first wireless device, where the model determines an output data based on an input data associated with channel information.

In some embodiments, the channel information includes a plurality of channel paths, the first wireless device receives an information indicating a total number of the plurality of channel paths. In some embodiments, the first wireless device receives a time gap information that indicates a time gap between two consecutive channel paths included in the input data. In some embodiments, the first wireless device receives a quantization accuracy indication of an element included in the input data, the element includes any one or more of the following: a first power of a channel path, a second power of an in-phase of the channel path, a third power of a quadrature part of the channel path, or a path phase. In some embodiments, the input data include channel information from a multi-port reference signal.

In some embodiments, the input data include channel information related to a power and a phase of a channel path. In some embodiments, the input data includes channel information related to a power of an in-phase and a quadrature part of a channel path. In some embodiments, the input data includes channel information related to multiple reference signals received from a same transmission reception point (TRP) device. In some embodiments, the output data includes any one or more of the following: a location of a communication device, at least one confidence level, a timing information, or a reference signal received power (RSRP) information. In some embodiments, the timing information includes at least one reference signal time difference value, and the at least one downlink reference signal time difference value is a relative timing difference between a neighbor transmission reception point (TRP) and a reference TRP. In some embodiments, the RSRP information includes at least one reference signal received path power value, wherein the at least one reference signal received path power value is a differential value between a reference signal received path power value corresponding to a target reference signal and another reference signal received path power value corresponding to another reference signal.

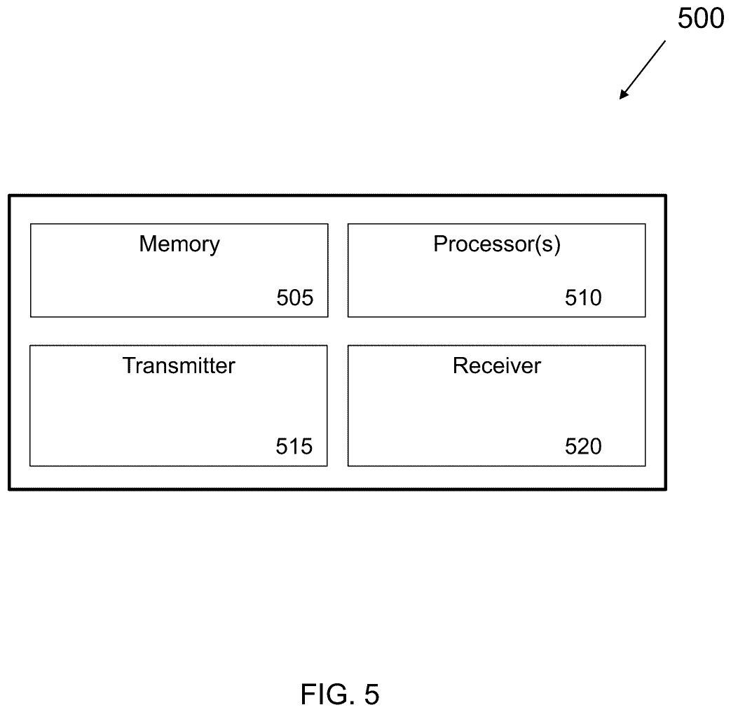

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4 and 6 to 9, and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

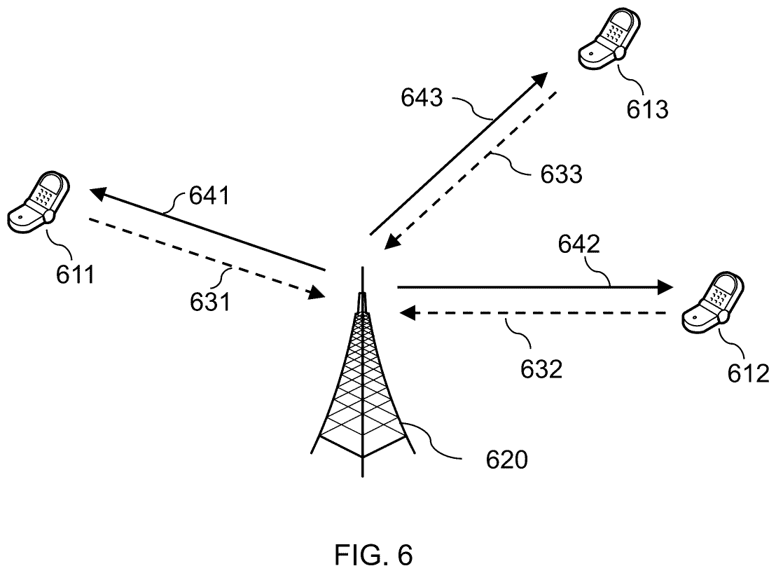

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
receiving, by a first wireless device from a second device, a request message that requests the first wireless device to report at least a path phase of a channel path; and
transmitting, to the second device and in response to the request message, the path phase of the channel path.

2. The method of claim 1,
wherein the request message requests the first wireless device to report the path phase, a path timing, and a path power of the channel path, and
wherein the first wireless device transmits a set of data comprising the path phase, the path timing, and the path power in response to the request message.

3. The method of claim 2, wherein the first wireless device includes a communication device.

4. The method of claim 3, wherein the path power is a downlink reference signal received path power.

5. The method of claim 3, wherein the set of data comprising the path phase, the path timing, and the path power is transmitted to the second device in a downlink measurement report using a downlink time difference of arrival (DL TDOA) positioning method and/or a Multi-cell round trip time (Multi-RTT) positioning method.

6. The method of claim 3,
wherein, prior to the receiving the request message by the communication device,
the communication device transmits to the second device an indication that indicates
that the communication device has a capability to report the path phase, and
wherein the request message is received in response to transmitting the indication.

7. A wireless communication method, comprising:
transmitting, by a second device to a first wireless device, a request message that requests the first wireless device to report at least a path phase of a channel path; and
receiving, from the first wireless device and in response to the request message, the path phase of the channel path.

8. The method of claim 7,
wherein the request message requests the first wireless device to report the path phase, a path timing, and a path power of the channel path, and
wherein the second device receives a set of data comprising the path phase, the path timing, and the path power in response to the request message.

9. The method of claim 8, wherein the first wireless device includes a communication device, and wherein the second device includes a location entity.

10. The method of claim 9, wherein the set of data comprising the path phase, the path timing, and the path power is received by the second device in a downlink measurement report using a downlink time difference of arrival (DL TDOA) positioning method and/or a Multi-cell round trip time (Multi-RTT) positioning method.

11. The method of claim 9,
wherein, prior to the transmitting the request message by the second device, the second device receives an indication that indicates that the communication device has a capability to report the path phase, and
wherein the request message is transmitted in response to receiving the indication.

12. An apparatus for wireless communication comprising one or more processors configured to cause the apparatus to:
receive, by a first wireless device from a second device, a request message that requests the first wireless device to report at least a path phase of a channel path; and
transmit, to the second device and in response to the request message, the path phase of the channel path.

13. The apparatus of claim 12,
wherein the request message requests the first wireless device to report the path phase, a path timing, and a path power of the channel path, and
wherein the first wireless device transmits a set of data comprising the path phase, the path timing, and the path power in response to the request message.

14. The apparatus of claim 13, wherein the first wireless device includes a communication device.

15. The apparatus of claim 14, wherein the path power is a downlink reference signal received path power.

16. The apparatus of claim 14, wherein the set of data comprising the path phase, the path timing, and the path power is transmitted to the second device in a downlink measurement report using a downlink time difference of arrival (DL TDOA) positioning method and/or a Multi-cell round trip time (Multi-RTT) positioning method.

17. An apparatus for wireless communication comprising one or more processors configured to cause the apparatus to:
transmit, by a second device to a first wireless device, a request message that requests the first wireless device to report at least a path phase of a channel path; and
receive, from the first wireless device and in response to the request message, the path phase of the channel path.

18. The apparatus of claim 17,
wherein the request message requests the first wireless device to report the path phase, a path timing, and a path power of the channel path, and
wherein the second device receives a set of data comprising the path phase, the path timing, and the path power in response to the request message.

19. The apparatus of claim 18, wherein the first wireless device includes a communication device, and wherein the second device includes a location entity.

20. The apparatus of claim 19, wherein the set of data comprising the path phase, the path timing, and the path power is received by the second device in a downlink measurement report using a downlink time difference of arrival (DL TDOA) positioning method and/or a Multi-cell round trip time (Multi-RTT) positioning method.
